(19) United States
(12) Patent Application Publication
(10) Pub. No.: US 2021/0086200 A1
(43) Pub. Date: Mar. 25, 2021

(54) CENTRIFUGE HAVING TUBE HOLDERS

(71) Applicant: Miron Research and Development in Dentistry, LLC, Venice, FL (US)

(72) Inventor: Richard Miron, Venice, FL (US)

(21) Appl. No.: 17/011,200

(22) Filed: Sep. 3, 2020

Related U.S. Application Data
(60) Provisional application No. 62/905,527, filed on Sep. 25, 2019.

(51) Int. Cl. B04B 5/02; B04B 5/04

(52) U.S. Cl. CPC B04B 5/02; B04B 5/0421

(57) ABSTRACT

A centrifuge device operably configured to simultaneously spin multiple sample tubes at different g-forces during a single centrifugation cycle. The centrifuge device includes a base and a rotatable member disposed within the base and configured as a rotor. The rotatable member includes a plurality of receptacles and a center portion, and wherein each of the receptacles is spaced equally apart from the center portion. The centrifuge also includes a first tube holder selectively inserted within one of the receptacles, wherein the first tube holder includes a first tube therein and a second tube holder selectively inserted within another one of the receptacles, wherein the second tube holder includes a second tube therein. The first tube is operably configured to be spun at a different relative centrifugal force than the second tube.

### CROSS REFERENCE TO RELATED APPLICATIONS

111 The present application claims the benefit to U.S. Provisional Patent Application No. 62/905,527 filed on Sep. 25, 2019, which is incorporated herein by reference in its entirety.

### FIELD

The present disclosure generally relates to a centrifuge having tube holders, wherein the centrifuge is configured to simultaneously produce two relative centrifugal force (RCF) values during the same centrifugation cycle.

### BACKGROUND

A centrifuge is a piece of equipment the puts an object in rotation around a fixed axis, applying a force perpendicular to the axis. A centrifuge is generally driven by an electric motor. In the centrifuge, centripetal acceleration causes more dense substances to separate out along the radial direction (bottom of a tube). Simultaneously, lighter objects tend to move to the top of a tube and effective separation of substances occurs based on density.

Protocols for centrifugation typically specify the amount of acceleration to be applied to a sample, such as revolutions per minute. A g-force or relative centrifugal force (RCF) is the amount of acceleration to be applied to a sample. It depends on the revolutions per minute (RPM) and the radius of a centrifuge rotor, and is relative to the force of Earth's gravity.

Fluids, such as whole blood or other biological fluids, may be separated into fractions. For example, red blood cells, white blood cells, platelets, and plasma may be separated in a centrifuge based on the differences in their density. A whole blood sample may be placed in a test tube, or other similar device, which is then spun in a centrifuge at a specified speed. The generated centrifugal force separates the blood into different fractions based on specific densities.

Centrifuges are typically designed with sample tube holders having the same sizes and configurations in order to accommodate the same types of tubes. Most samples are centrifuged simultaneously at the same RCF values during the same centrifugation cycle. However, certain recent protocols for centrifuging certain biological fluids, such as platelet concentrates, require spinning at multiple different RCF values for various applications. Since the tube holders in existing centrifuges are usually identical, they can only be spun at the same speed and the same g-force. This is particularly problematic when trying to achieve an optimal solution, such as when producing platelet rich fibrin (PRF) clots and PRF liquid through spinning platelets, since both protocols require spin cycles at different g-forces and most clinicians prefer not to draw blood from patients more than once. Spinning these samples at one protocol is simply not effective for achieving multiple applications since multiple blood draws must be done or inefficient cell layer separation of either protocol must occur.

Consequently, there is a need for a centrifuge that may simultaneously spin various samples at different g-forces during the same centrifugation cycle.

### SUMMARY

What is provided is a centrifuge operably configured to simultaneously spin multiple sample tubes at different g-forces during a single centrifugation cycle.

In an embodiment, a centrifuge device includes a base and a rotatable member disposed within the base and configured as a rotor. The rotatable member includes a plurality of receptacles and a center portion, and wherein each of the receptacles is spaced equally apart from the center portion. The centrifuge also includes a first tube holder selectively inserted within one of the receptacles, wherein the first tube holder includes a first tube therein and a second tube holder selectively inserted within another one of the receptacles, wherein the second tube holder includes a second tube therein. The radial distance between the first tube and the center portion of the rotatable member is less than the radial distance between the second tube and the center portion of the rotatable member. The first tube is operably configured to be spun at a different relative centrifugal force than the second tube. As a result, first tube is operably configured to be spun at a lower relative centrifugal force than the second tube during the same centrifugation cycle.

In some embodiments, the first tube holder has a smaller length than the second tube holder.

In some embodiments, a plug (e.g., stopper) is positioned within the first tube holder between the bottom of the first tube holder and the bottom of the first tube.

In an alternative embodiment, a centrifuge device includes a base; a first rotatable member disposed within the base and configured as a rotor, wherein the first rotatable member includes a first set of receptacles and a first center portion, and wherein the first set of receptacles are spaced equally apart from the first center portion; and a second rotatable member disposed within the base and configured as a rotor, wherein the second rotatable member includes a second set of receptacles and a second center portion, and wherein the second set of receptacles are spaced equally apart from the second center portion. The radius of the rotatable member is different than the radius of the second rotatable member. The device also includes a first set of tube holders selectively inserted within the first set of receptacles and a second set of tube holder selectively inserted within the second set of receptacles.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 illustrates a schematic perspective view of a centrifuge device having a rotatable member and tube holders according to an embodiment of the disclosure;

FIG. 2 illustrates a schematic top perspective view of the rotatable member and the tube holders illustrated in FIG. 1;

FIG. 3 illustrates a schematic side sectional view of an interior portion of the centrifuge device illustrated in FIGS. 1 and 2;

FIG. 4 illustrates a schematic elevation view of the tube holders illustrated in FIG. 3;

FIG. 5 illustrates a schematic perspective view of one of the tube holders illustrated in FIGS. 3 and 4;

FIG. 6 illustrates a schematic perspective view of a centrifuge device having a rotatable member and tube holders according to an alternative embodiment of the disclosure;

FIG. 7 illustrates a schematic perspective view of the rotatable member and the tube holders illustrated in FIG. 6, wherein one of the tube holders is illustrated via a sectional view;

FIG. 8 illustrates another schematic perspective view of the rotatable member and the tube holders illustrated in FIGS. 6 and 7, wherein one of the tube holders is illustrated via a sectional view;

FIG. 9 illustrates a schematic perspective view of a stopper found in the tube holder illustrated FIGS. 8; and

FIG. 10 illustrates a schematic top perspective view of a centrifuge device according to yet another embodiment of the disclosure, wherein the centrifuge device includes two rotating members.

### DETAILED DESCRIPTION

It is to be understood that the present disclosure may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

As used herein, the terms “relative centrifugal force”, “RCF”, and “g-force” are understood to refer to the force attributable to rotation of the centrifuge and the amount of acceleration to be applied to a sample.

As used herein, the term “centrifuge” means a device comprising a compartment spun about a center axis to separate materials of different density or to simulate gravity with centrifugal force.

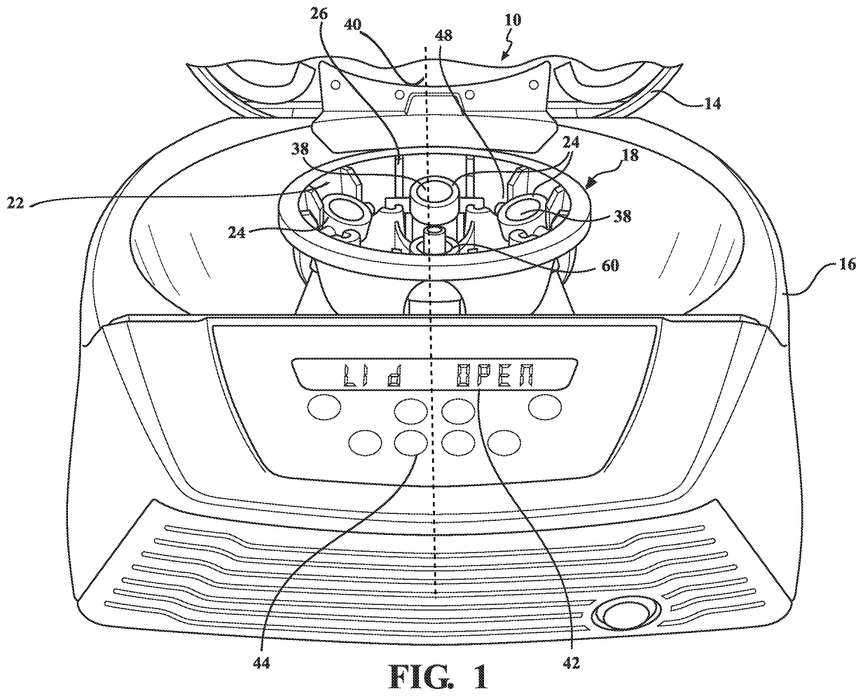

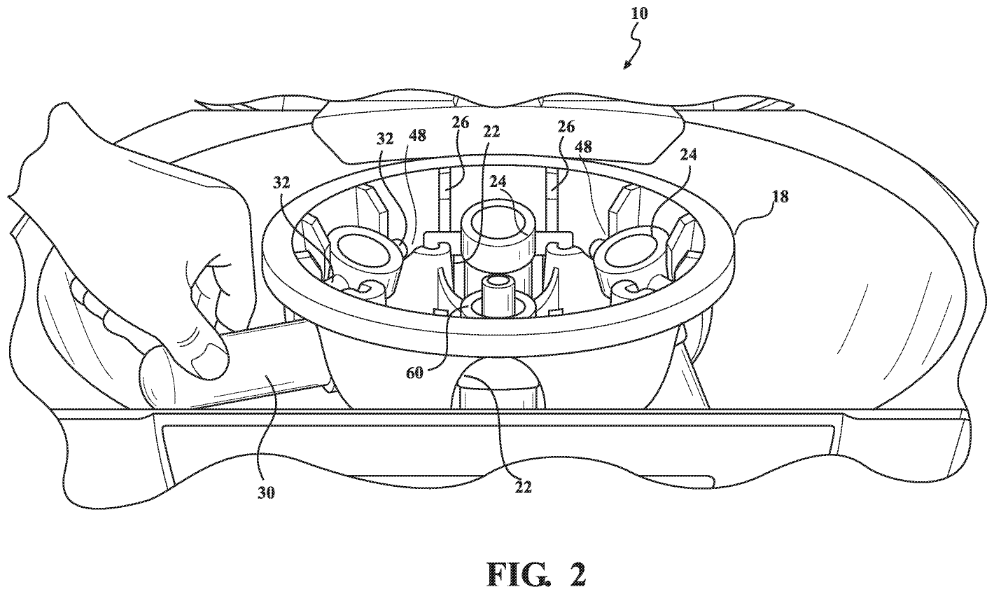

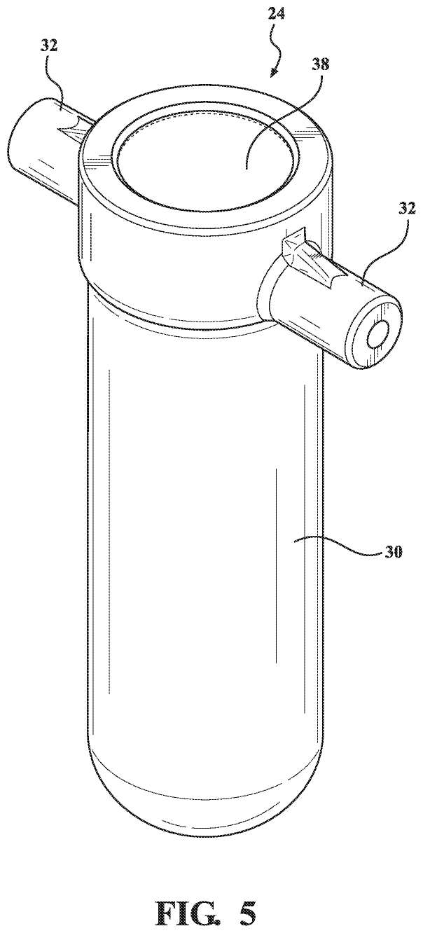

FIGS. 1-5 show views of a centrifuge device 10 having a rotatable member 18 and a plurality of tube holders 24 according to an embodiment of the disclosure. The device 10 comprises a motor (not shown) for rotating the rotatable member 18 about a vertical axis 40. The device 10 further comprises a hollow plastic or metal base portion 16. The base portion 16 includes an open top portion and a cover or lid 14 hingedly attached to the base portion 16 for movement between the open configuration (shown in FIGS. 1 and 2), in which the top portion exposes internal components of the device 10, and a closed configuration.

The rotatable member 18 is disposed in the base portion 16 and may be generally cylindrical in shape. The rotatable member 18 may be configured as a hollow rotor, such as a swing out rotor or a fixed angle rotor. The rotatable member 18 may be rotatably mounted in the base portion 16. One of ordinary skill in the art would understand that the rotatable member 18 may have other shapes and configurations in other embodiments.

The rotatable member 18 includes an interior surface having a plurality of receptacles 22. As best shown in FIGS. 1 and 2, each of the receptacles 22 may be spaced equally apart from each other and from a center portion 60 within the rotatable member 18. In an alternative embodiment, the receptacles 22 are not spaced evenly from each other or from the center portion 60.

Each of the receptacles 22 defines an opening extending through the interior surface. Each of the receptacles 22 is configured to selectively receive a respective tube holder 24. The receptacles 22 allow the tube holders 24 to rotate at the same speed as the rotatable member 18 rotates. The rotatable member 18 and the tube holders 24 may each be made of light weight material since they are meant to be exposed to high g-forces, such as up to 3000 Gs.

Each of the receptacles 22 may include angled protrusions 26 that define a groove 48. At least a portion of each of the tube holders 24 may rest within the grooves 48 in order to ensure that the tube holders 24 remain in position when the device 10 is spinning. In the embodiment shown in FIGS. 1 and 2, the base portion 16 includes six receptacles 22 and six tube holders 24 positioned within each of the receptacles 22. However, one of ordinary skill in the art would understand that the base portion 16 may include either more or less than six receptacles 22 and either more or less than six tube holders 24.

As best shown in FIGS. 1, 2, and 5, each of the tube holders 24 includes a tube cavity 38 into which a respective tube 28, such as a test tube, may be inserted. The tubes 28 hold various solid, liquid, and/or plasma materials, such as blood samples, to be separated by the device 10.

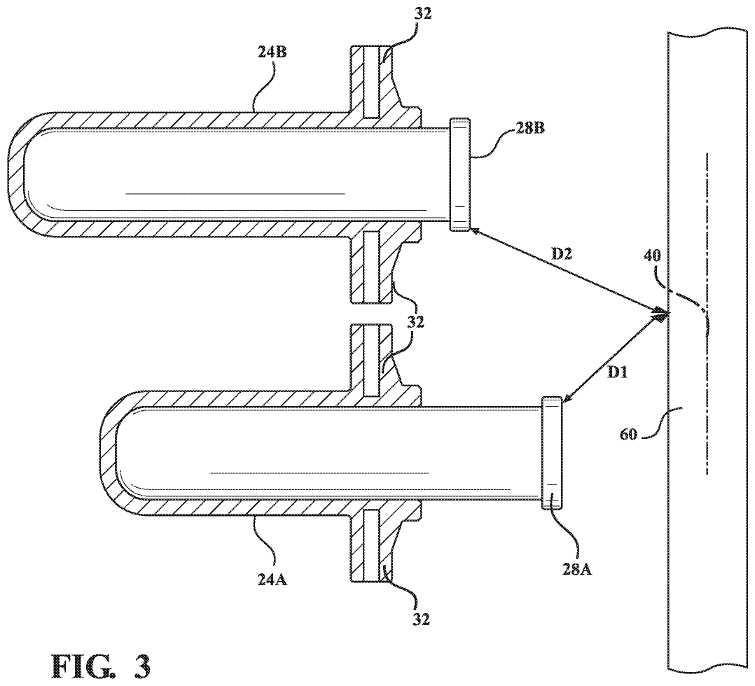

As best shown in FIGS. 3-5 and as a non-limiting example, the tube holders 24 also include a generally cylindrical body 30 having an upper portion 34 and a lower portion 36. Two opposing members 32 extending axially from the upper portion 34 of the body 30 of each of the tube holders 24. As a result, the members 32 are positioned transverse to the body 30.

As best seen in FIG. 2, each of the members 32 is configured to rest within one of the grooves 48 such that the tube holders 24 remain in place between two of the protrusions 26 of the rotatable member 18. The rotatable member 18 provides clearance for the tube holders 24 to pivot from a vertical orientation to a horizontal orientation (or a substantially horizontal orientation) during centrifuging. For example, the g-force experienced by the tube holders 24 when the tube holders 24 are inclined at an angle of about 90 degrees may be between about 50 and 3000 Gs.

As best shown in FIG. 1, the tube holders 24 are in a vertical configuration when the rotatable member 18 does not rotate. In the vertical configuration, upper portions 34 of the tube holders 24, including the axially extending portions 32, are vertically above the lower portions 36 of the tube holders 24. When the rotatable member 18 is rotated, the tube holders 24 pivot in their respective receptacles 22 to a horizontal configuration, in which the upper portions 34 are radially inward of the lower portions 36 and closer to the center portion 60.

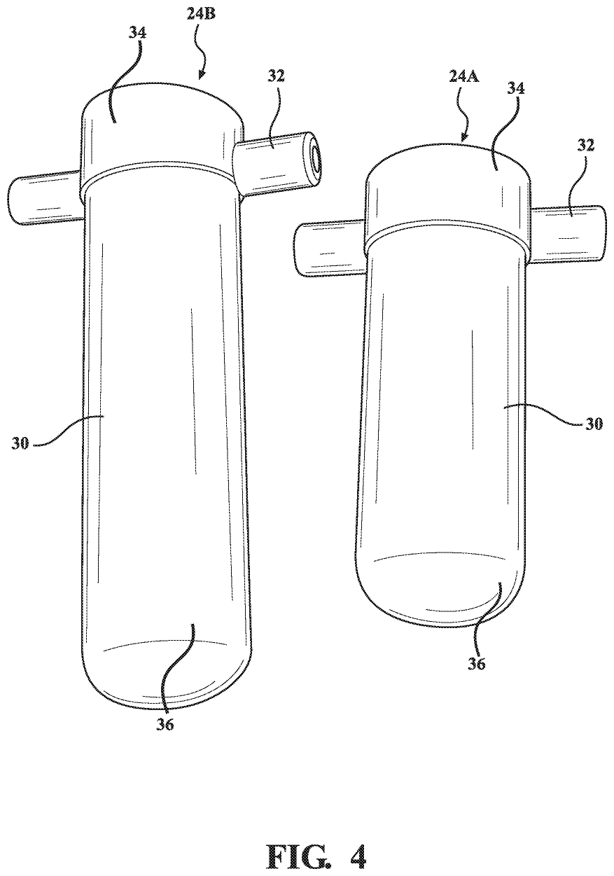

As best shown in FIGS. 3 and 4 and as a non-limiting example, at least one first tube holder 24A has a different length than at least one second tube holder 24B. In an embodiment, the length of the body 30 of the first tube holder 24A may be between about 35 and 75 mm and the length of the body 30 of the second tube holder 24B may be between about 85 mm and 120 mm. However, one of ordinary skill in the art would appreciate that the dimensions of the bodies 30 of the tube holders 24 may vary in other embodiments.

In an embodiment, there are three first tube holders 24A and three second tube holders 24B. Despite the differences in lengths between the first tube holders 24A and second tube holders 24B, the same size and types of tubes 28 may fit within the cavities 38 of the first and second tube holders 24A, 24B. One of ordinary skill in the art would understand that the amount of first tube holders 24A and the amount of second tube holders 24B in the device 10 may vary in other embodiments.

As best seen in FIG. 3, the radial distance D1 between the top of a first tube 28A in the first tube holder 24A and the center portion 60 is less than the radial distance D2 between the top of a second tube 28B in the second tube holder 24B and the center portion 60 of the rotatable member 18 when the first and second tube holders 24A, 24B are inclined at angles that are not vertical during centrifuging. The radial distances from portions of the tubes 28A, 28B to the center portion 60 of the rotatable member 18 may be predetermined and varied to optimize the design of the device 10 in other embodiments.

Since the first tube holder 24A is shorter than the second tube holder 24B, the first tube 28A protrudes out further from the first tube holder 24A and is closer to the center portion 60 than the second tube 28B. As a result, the first tube 28A and the first tube holder 24A experience a lower g-force compared with the g-force experienced by the second tube 28B and the second tube holder 24B in one centrifugation cycle. For example, the g-force associated with the first tube 28A may be between about 60 and 2000 Gs and the g-force associated with the second tube 28B may be between about 200 and 3000 Gs. However, one of ordinary skill in the art would appreciate that the g-force associated with the tubes 28 may vary in other embodiments.

The centrifuge device 10 may comprise at least four tube holders 24 with different lengths allowing at least two of the same tubes 28 to be positioned at different radial distances with respect to the vertical axis 40 and the center portion 60. As best seen in FIGS. 1 and 2, the device 10 comprises six tube holders 24 that are spaced about the same distance apart from each other on the rotor/rotatable member 18. As a result, the centrifuge device 10 may be spun at different g-forces at the same time using the same speed (RPM). The ability to spin the centrifuge device 10 at different g-forces offers several benefits, including the ability to account for multiple centrifuge protocols requiring different g-forces/speeds in a single centrifuge spin for a particular fluid sample.

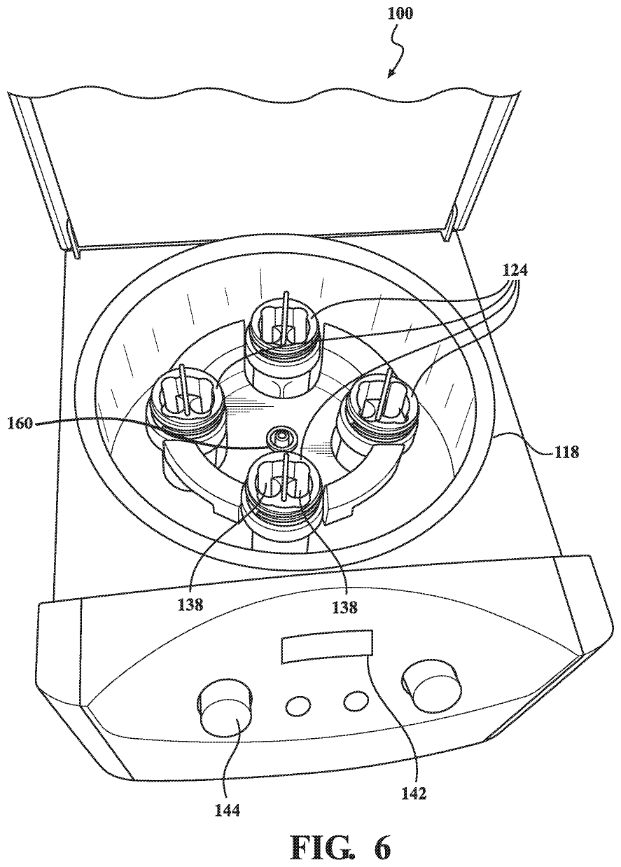

FIGS. 6-9 illustrate views of a centrifuge device 100 having a rotor/rotatable member 118 and a plurality of tube holders 124 according to another embodiment of the disclosure. In this embodiment, the centrifuge device 100 comprises four tube holders 124 that are spaced about the same distance apart from each other and about the same distance from a center portion 160 of the rotor/rotatable member 118. In this embodiment, each of the tube holders 124 is essentially identical.

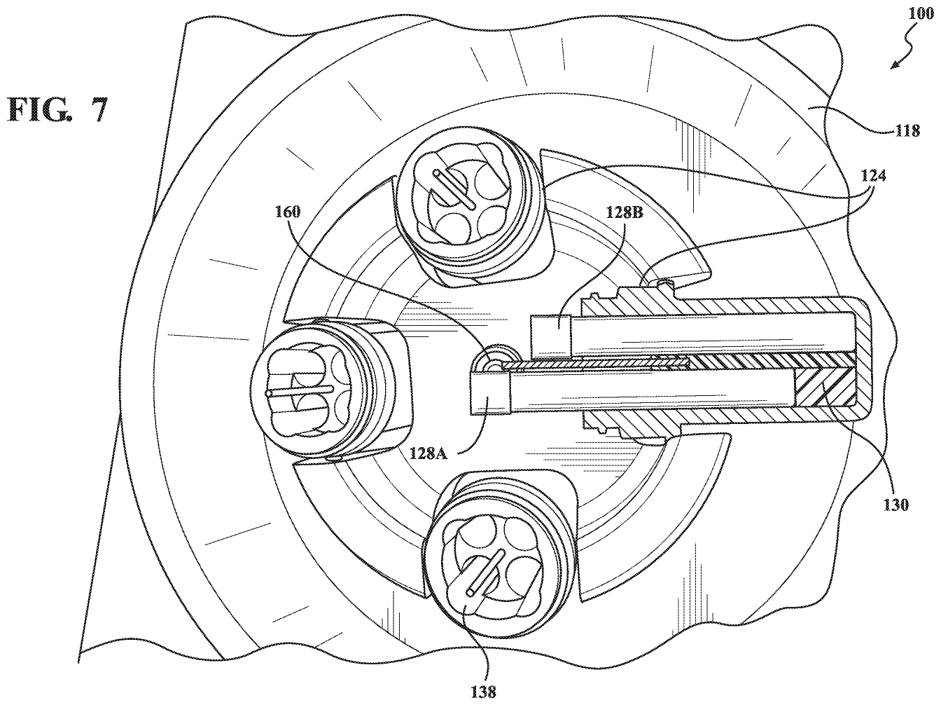

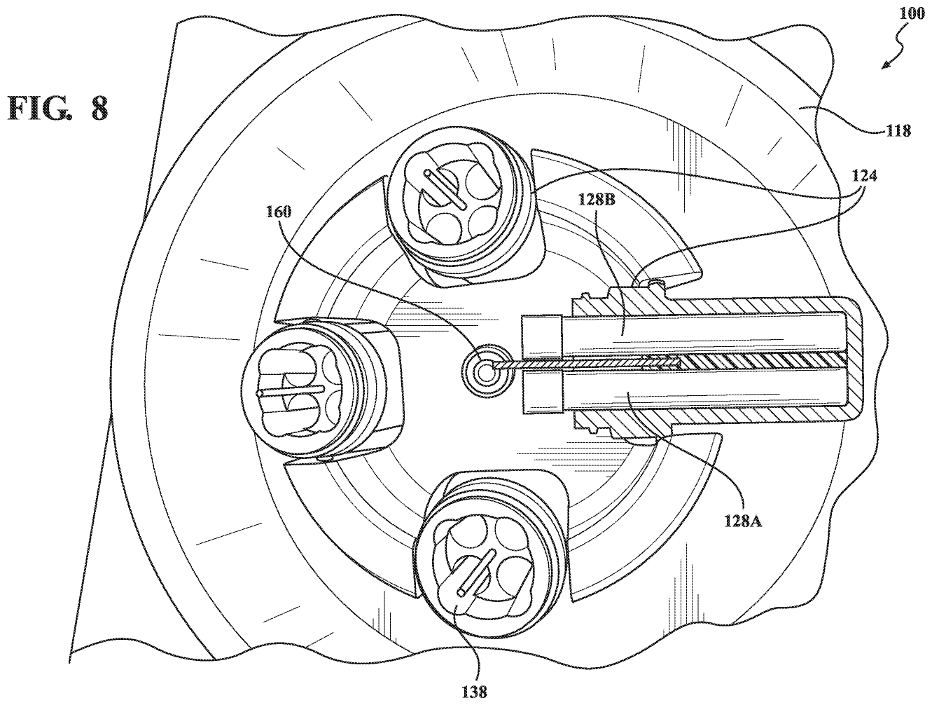

The rotatable member 118 provides clearance for the tube holders 124 to pivot from a vertical orientation to a substantially horizontal orientation during centrifuging, as best seen in FIGS. 7 and 8. The g-force at the substantially horizontal orientation where the tube holders 124 are inclined at an angle of about 90 degrees from the vertical orientation may be between about 200 and 3000 Gs.

As best seen in FIGS. 7 and 8, each of the tube holders 124 includes a plurality of tube cavities 138 into which a respective tube 128, such as a test tube, may be placed. The rotatable member 118 and the tube holders 124 may both be made of light weight material since they are meant to be exposed to high g-forces, such as up to 3000 Gs. The tubes 128 hold material having constituents, such as blood samples, to be separated by the device 100.

The tube holders 124 and the tubes 128 are in a vertical configuration when the rotatable member 118 does not rotate. When the rotatable member 118 is rotated, the tube holders 124 pivot to a horizontal configuration, in which the tube holders 124 and the tubes 128 are directed towards the center portion 160 of the rotor/rotatable member 118.

As best seen in FIG. 8 and as a non-limiting example, a plug, such as a stopper 130, is positioned at the bottom of one of the tube cavities 138 of a first tube holder 124A, while the second tube holder 124B does not include the stopper 130. The stopper 130 provides distance between the bottom of the first tube holder 124A and the bottom of a first tube 128A. As a result, the top of the first tube 128A extends further out of the first tube holder 124A and closer to the center portion 60 than the second tube 128B in the second tube holder 124B.

During operation of the centrifuge device 100 in this embodiment, the g-force associated with the first tube 128A is less than the g-force associated with the second tube 128B. For example, the g-force associated with the first tube 128A may be between about 60 and 2000 Gs and the g-force associated with the second tube 128B may be between about 200 and 3000 Gs. However, one of ordinary skill in the art would appreciate that the g-force associated with the tubes 128 may vary in other embodiments.

As best seen in FIG. 7, the tube holder 124 does not include a stopper. As a result, the first tube 128A extends from the tube holder 124 and is about the same distance away from the center portion 60 at as the second tube 128B. Consequently, the g-force associated with the first tube 128A may be about the same as the g-force associated with the second tube 128B.

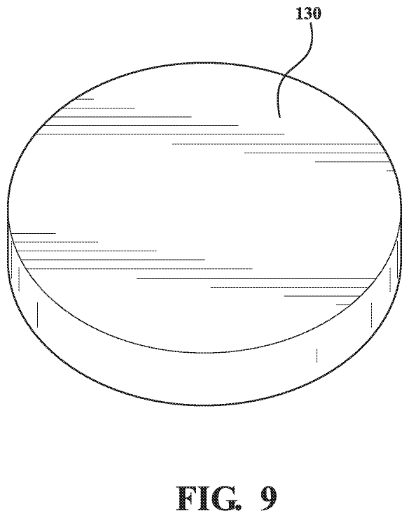

The stopper 130 may be fabricated from a variety of materials, including, but not limited to rubber, PLLA, plastic, PET, metal, and/or any combinations thereof. The stopper 130 may have any shape or configuration so long as it is able to fit at the bottom of the tube holders 124 and not damage the tubes 128 while the tubes 128 are spinning. In the embodiment shown in FIG. 9, the stopper 130 is circular in shape and comprises a cushion made from rubber.

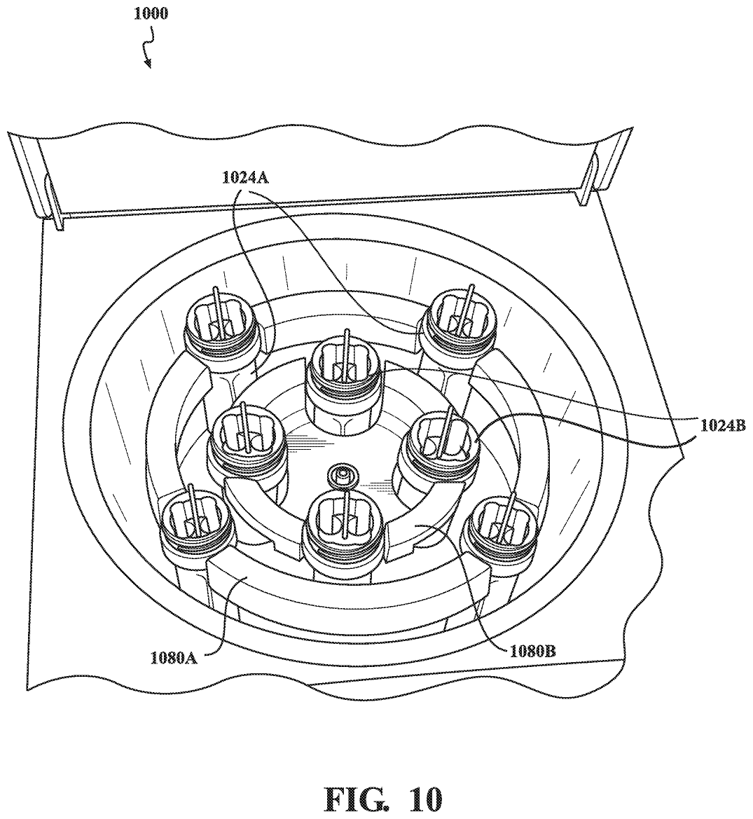

FIG. 10 shows a schematic perspective view of a centrifuge device 1000 according to yet another embodiment of the disclosure, wherein the centrifuge device 1000 includes two separate rotors/rotatable members 1080 and two sets of tube holders 1024 positioned therein. In this embodiment, the rotors/rotatable members 1080 rotate at the same speed as the sets of tube holders 1024 the that are positioned within the rotors/rotatable members 1080.

In the embodiment shown in FIG. 10, a first rotor/rotatable member 1080A includes a first set of tube holders 1024A and a second rotor/rotatable member 1080B includes a second set of tube holders 1024B. The first rotor/rotatable member 1080A has a larger radius than the radius of the second rotor/rotatable member 1080B. During operation of the centrifuge device 1000, both of the rotor/rotatable member 1080A, 1080B spin during one centrifugation cycle. The rotors/rotatable members 1080 may simultaneously generate a plurality of RCF values for various samples during one centrifugation cycle when centrifuged at a single RPM value. In this embodiment, the first rotor/rotatable member 1080A and the first set of tube holders 1024A spin at a higher g-force than the second rotor/rotatable member 1080B and the second set of tube holders 1024B.

The rotors/rotatable members 1080 shown in FIG. 10 may be made from the same material, but have different dimensions or configurations. In the embodiment shown in FIG. 10, there are 4 tube holders 1024 on each of the rotors/rotatable members 1080. One of ordinary skill in the art would understand that other amounts of tube holders may exist for each rotor/rotatable member in other embodiments. In yet another embodiment, one rotor/rotatable member may have a different number of tube holders than the other rotor/rotatable member.

As best shown in FIGS. 1 and 6 and as a non-limiting example, the centrifuge devices 10/100/1000 may each include a display 42/142, such as but not limited to an LCD, for presenting visual data pertaining to the device 10/100/1000 and its operation, such as the revolutions per minute (RPM) of the rotatable member 18/118 and the time period of centrifuging. One or more selectors 44/144 may be provided for manipulation by a user to increase and decreased the desired time of centrifuging, the RPM at which centrifuging takes place, and the speed of centrifuging.

Examples for using the centrifuge devices having tube holders disclosed herein are provided below. These examples are for illustrative purposes only and in no way limit the scope of the disclosure.

### Example 1

Typically, solid PRF clots produced via horizontal centrifugation require centrifugation speeds of 700 g. This produces a 4 mL (from a 10 mL tube) clot utilized for regenerative purposes as a barrier with host growth factors and cells including platelets and leukocytes. During regenerative processes, solid-PRF clots are often combined with liquid PRF that typically produce a 1.5 mL liquid PRF that may be injectable or further induce clotting. Protocols to produce liquid PRF favor a much slower centrifugation speed (200-300 g) in order to stay liquid and produce a 1.5 mL plasma layer of highly concentrated cells and growth factors. Unfortunately, clinicians must either draw blood twice from the patient doubling the material costs and also harvesting from the patient twice, or utilize only 1 protocol to produce both solid-PRF clots and liquid-PRF ineffectively. The centrifuge devices 10/100 disclosed herein are configured to spin 2 centrifugation RCF values simultaneously based on the modifications to the lengths of the tube holders 24/124. As a result, 2 separate g-forces can be produced within the same centrifugation cycle.

### Example 2

The isolation of stem cells and blood concentrates. Typically stem cells and platelet concentrates are utilize for regenerative purposes yet both require various centrifugation RCF values to isolate various cell types from different areas of the body (for example bone marrow aspirates versus blood collected from peripheral veins). By developing a centrifugation system with modification to tube holder lengths, protocols can be achieved in the same centrifuge simultaneously.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to from the inventive concepts defined in the appended claims.

In accordance with the provisions of the patent statutes, the present disclosure has been described to represent what is considered to represent the preferred embodiments. However, it should be noted that this disclosure can be practiced in other ways than those specifically illustrated and described without departing from the spirit or scope of this disclosure.

What is claimed is:

1. A centrifuge device comprising:
a base;
a rotatable member disposed within the base and configured as a rotor, wherein the rotatable member includes a plurality of receptacles and a center portion, and wherein each of the receptacles is spaced equally apart from the center portion;
a first tube holder selectively inserted within one of the receptacles, wherein the first tube holder includes a first tube therein;
a second tube holder selectively inserted within another one of the receptacles, wherein the second tube holder includes a second tube therein;
wherein the radial distance between the first tube and the center portion of the rotatable member is less than the radial distance between the second tube and the center portion of the rotatable member; and
wherein the first tube is operably configured to spin at a different relative centrifugal force than the second tube.

2. The centrifuge device of claim 1, wherein each of the first and second tube holders includes a body and a pair of opposing members extending axially from the body.

3. The centrifuge device of claim 2, wherein each of the receptacles includes one or more angled protrusions defining a groove, and wherein the opposing members of the tube holders are positioned within the grooves.

4. The centrifuge device of claim 1, wherein a plug is positioned within the first tube holder between the bottom of the first tube holder and the bottom of the first tube.

5. The centrifuge device of claim 4, wherein the plug comprises rubber, polyester, plastic, metal, or any combinations thereof.

6. The centrifuge device of claim 1, wherein the first tube is operably configured to be spun at a lower relative centrifugal force than the second tube during one centrifugation cycle.

7. The centrifuge device of claim 1, wherein the first tube holder has a smaller length than the second tube holder.

8. A centrifuge device comprising:
a base;
a first rotatable member disposed within the base and configured as a rotor, wherein the first rotatable member includes a first set of receptacles and a first center portion, and wherein the first set of receptacles are spaced equally apart from the first center portion;
a second rotatable member disposed within the base and configured as a rotor, wherein the second rotatable member includes a second set of receptacles and a second center portion, and wherein the second set of receptacles are spaced equally apart from the second center portion;
wherein the radius of the first rotatable member is different than the radius of the second rotatable member;
a first set of tube holders selectively inserted within the first set of receptacles; and
a second set of tube holder selectively inserted within the second set of receptacles.

9. The centrifuge device of claim 8, wherein the first rotatable member is operably configured to spin at a lower relative centrifugal force than the second rotatable member during one centrifugation cycle.
